(19) United States
(12) Patent Application Publication
(10) Pub. No.: US 2014/0214566 A1
(43) Pub. Date: Jul. 31, 2014

(54) Retail Gift Card System with Integrated Account and Sales Receipt Tracking

(71) Applicant: WAL-MART STORES, INC., Bentorville, AR (US)

(72) Inventors: Donald Ray High, Noel, MO (US); Michael D. Atchley, Springdale, AR (US); Andrew C. Hardin, Bentonville, AR (US); Nicholas D. Rone, Bella Vista, AR (US)

(73) Assignee: WAL-MART STORES, INC., Bentonville, AR (US)

(21) Appl. No.: 13/751,584

(22) Filed: Jan. 28, 2013

(51) Int. Cl. G06Q 20/20

(52) U.S. Cl. CPC G06Q 20/20; G06Q 20/3433
USPC 705/17

(57) ABSTRACT

A retail gift card system with integrated account and electronic receipt tracking is disclosed. The retail gift card system comprises an internet-accessible customer account and a customer account linked gift card. The gift card is used to purchase merchandize from a retailer-operated store, whereupon transaction data, monetary value data, and/or electronic receipt data is contemporaneously captured and stored on a retailer-operated computer network in association with the customer account. To promote customer convenience, the gift card is provided with a machine-readable link to the customer account, thereby enabling “on-the-spot” access using, for example, a smartphone. Particular embodiments of the system include a balance depositing function and/or electronic coupon and warranty coupling.

### FIELD

In general, the present invention provides a retail gift card system, and more particularly, a retail gift card system with integrated account and sales receipt tracking capabilities.

### BACKGROUND

The adoption and development of gift cards and related technologies within the retail industry continues to expand and evolve.

A gift card functions essentially as a monetary equivalent redeemable by a customer (i.e., a card holder) towards the purchase of merchandise. The popularity of exchanging such cards as gifts, in some regards, can be attributed to the convergence of convenience and utility. In respect of convenience, gift cards enable comparatively easy cash-less transactions and are transferable easily between individuals. Distinct from cash however, gift cards have specific utility that can be defined by a card's issuer.

For retailers, gift cards are often used to promote customer retention and loyalty. For example, so-called “closed-loop” gift cards are redeemable only at retailer-operated establishments, thereby encouraging customer patronage and retention of revenue. Studies of customer buying patterns have also shown that gift cards are often redeemed to purchase items priced in excess of the card's monetary value. In addition to this increased revenue, if monitored and tracked, gift card redemption can also lead to valuable customer shopping data useful in developing retail analytics and statistics.

Clearly, meaningful economic incentives exists for establishing and promoting retail gift card programs. However, gift card programs, including related technologies and variants thereof, are now quite well known, having been widely explored and implemented by most, if not all, major retailers. Substantive differentiation—capable of renewing and/or engaging consumer interest—remains elusive. Continuing need thus exists for gift card systems having novel, even if subtle, specific utility.

### SUMMARY

In light of the above, the present invention provides a retail gift card system with integrated account and electronic receipt tracking functionality.

The retail gift card system, in particular, comprises an internet-accessible customer account and a customer account linked gift card. The gift card is used to purchase merchandize from a retailer-operated store, whereupon transaction data, monetary value data, and/or electronic receipt data is contemporaneously captured and stored on a retailer-operated computer network in association with the customer account. To promote customer convenience, the gift card is provided with a machine-readable link to the customer account, thereby enabling “on-the-spot” access using, for example, a smartphone. Particular embodiments of the system include a monetary balance depositing function and electronic coupon and warranty coupling.

It is principle object of the present invention to provide a retail gift card system with integrated account and electronic receipt tracking.

It is another object of the present invention to provide a retail gift card system having integrated means for recording and accessing electronic sales receipts within an associated internet-accessible gift card account.

It is another object of the present invention to provide a retail gift card system enabling access to an internet-accessible customer account through a machine-readable link on an associated gift card.

It is another object of the present invention to provide a retail card gift system comprising an internet-accessible gift card account and an account-linked gift card, the system including a balance depositing function.

It is another object of the present invention to provide a retail card gift system comprising an internet-accessible gift card account and an account-linked gift card, the system including electronic receipt tracking coupled with electronic coupon and warranty tracking.

For a further understanding of the nature and objects of the invention, reference should be had to the following description taken in conjunction with the accompanying drawings.

### BRIEF DESCRIPTION OF THE DRAWINGS

FIG. 1 illustrates schematically a customer-account linked gift card 10 and a smart phone 20 used to access an internet-accessible customer account 30 linked therewith.

FIG. 2 illustrates schematically a method for accessing an electronic receipt 228 utilizing a personal computer 220, the receipt being generated in accordance with the present invention.

FIG. 3 illustrates schematically a chronological sequence of gift card transactions 34a to 34g and the resulting input and output of data to and from a retailer-operated computer network 330.

### DETAILED DESCRIPTION

The present invention provides a retail gift card system that provides card holders on-line access to integrated account and receipt tracking functionality. This account and receipt tracker, among other functions, stores and makes available on a retailer-operated computer network the gift card's monetary value and transaction history, including electronic sale receipts generated at point-of-sale card redemption transactions. To provide such functions, the retail gift card system employs an internet-accessible customer account and a customer account linked gift card.

The internet-accessible customer account is hosted on the aforementioned computer network such that both transaction data and monetary value data relating to the gift card and its use by the “card holder” (hereinafter, “the customer”) can be stored on the computer network in association therewith. Once the gift-card is activated by the retailer, the associated transaction data and monetary value data becomes available to the customer when the customer accesses the customer account through the internet.

The customer account linked gift card is designed for use by the customer to purchase merchandise from the retailer, in particular, by applying the monetary value data associated therewith towards payment of said merchandise. Consistent with so-called “closed loop” gift card program design, purchases are restricted in the invention to merchandise available from or through the retailer.

Purchases made on or otherwise related to the gift card are recorded in the associated customer account, effecting both the transaction data and monetary value data stored therein.

As more fully described below, the customer account and data stored therein can be accessed by the customer using any of the currently well known procedures for “logging into” a internet-accessible account. To enhance customer convenience and accessibility, however, the customer account linked gift card is provided with machine-readable indicia encoding a link to said internet-accessible customer account. This novel feature enables a customer to access gift card data with comparative ease from virtually any location using, for example, a smartphone.

The computer network used by the retailer to host the retail card gift system is engineered in accordance with well known network architectures and topologies, and can comprise a plurality of interconnected client computers and terminals, servers, data storage facilities, hubs, routers, switches, network security devices, network management devices, wireless nodes and access points, load balancers, and related software. Within this network, the account-associated data is stored within the network's data storage facilities, with a web server providing an internet-based customer interface (e.g., a web site) and access to the account-account data.

In contrast to credit and bank cards issued by financial institutions, the customer account represented by the inventive retailer-issued gift card is not issued to any specific individual, but rather “linked” to a specific customer account (e.g., via a unique gift card identification code). Once activated by the retailer, subsequent activity by a customer using the gift card is not associated directly with that customer, but rather the linked customer account (e.g., by reference to the identification code).

When first acquired, the gift card's account will have a starting monetary value and either (a) no transaction data or (b) initial transaction data relating to the acquisition of the card (e.g., the date of card purchase and the purchase price). When the card is presented and used for purchasing merchandise at a retailer-operated store, the monetary value data in the linked customer account is reduced accordingly, and transaction data added to record the details of the purchase (e.g., date, merchandise, quantity, price, store location, coupons, warrantees, and other like transaction details). In accordance with the present invention, if an electronic sales receipt is generated and/or requested, that is added also.

Customer activity involving the gift card customer account need not necessarily relate to retail transactions, nor necessarily affect the account's monetary value and/or transaction data. For example, without purchasing any merchandise, a customer can add value to the gift card by either an online transfer of funds from a bank or by a cash deposit at a retailer-operated point of sale.

Likewise, the customer can voluntarily add non-transaction related data to the customer account, such as by adding an email address, product preferences and ratings, wish lists, local or favorite stores, residential zip code, shopping program and club memberships, etc., to an online user profile attached to the customer account. Such activity—though desirably included in the operation of the inventive gift card system—does not involve the purchase of merchandise, nor necessarily result in changes to the account's transaction or monetary value data.

Regardless of the types of data stored in the customer account, all or some predefined set thereof is engineered to be accessible by the customer through the internet. In the preferred embodiment, a website provides this access.

Preferably, the website is published through a retailer-operated web server, has a unique website URL, and is coded to provide good cross browser accessibility. User authentication can be provided, for example, by a login interface requiring entry of a gift card account ID number and a passcode.

Examples of currently available internet browsers includes, but is not limited to, the “Internet Explorer” browser (available from Microsoft Corporation, Redmond, Wash.), the “Safari” browser (available from Apple Inc., Cupertino, Calif.), the “Chrome” browser (available from Google Corporation, Mountain View, Calif.), the “Firefox” browser (an open source browser developed by the Mozilla Corporation and Foundation), and the “Opera” browser (available from Opera Software, Oslo, Norway).

Preferably, the HTML code for the website is written to enable access across a wide range of internet-enabled digital devices (e.g., personal computers, laptops, notebooks, tablets, and smartphones), with variant viewing display dimensions appropriately accommodated, for example, in the CSS style sheets thereof.

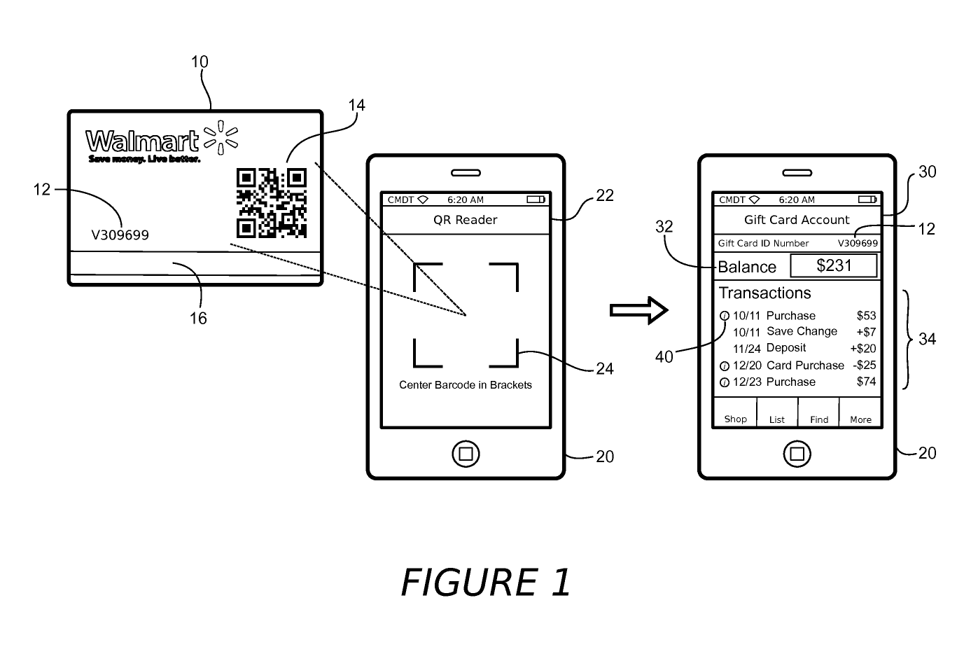

FIG. 1 illustrates a customer-account linked gift card 10 according to one embodiment thereof. As shown therein, the customer-account linked gift card 10 comprises a card identification number 12, a magnetic stripe 16, and machine-readable indicia 14. The relative location, sizes, and positioning of these elements are not fixed and can differ in varying embodiments within the scope of the present invention.

Any of the currently well known formats for gift-cards, including the manufacture, printing, design, and/or distribution thereof, can be employed. To illustrate, various gift card formats are disclosed, for example, in U.S. Pat. No. 6,493,970, issued to M. K. McCarthy et al. on Dec. 17, 2002; U.S. Pat. No. 7,770,802, issued to G. B. Dean et al. on Aug. 10, 2010; U.S. Pat. No. 8,038,067, issued to C. Albers et al. on Oct. 18, 2009; U.S. Pat. No. 8,061,619, issued to T. C. Halbur et al. on Nov. 22, 2011; U.S. Pat. No. 8,118,230, issued to D. M. Selg et al. on Feb. 21, 2012; U.S. Pat. No. 8,146,827, issued to T. C. Halbur et al. on Apr. 3, 2012; and U.S. Des. Pat. No. D569,902, issued to D. L. Chang et al. on May 27, 2008. As an alternative to standard wallet-sized gift cards, small key ring cards (also known as “key tags”) can be employed for convenience in carrying and ease of access.

Among other information, the magnetic stripe 16 is used to record account identification information, such as the gift card's unique account identification number. When the gift card is presented during check-out at a retailer-operated point-of-sale, the account identification information from magnetic stripe 16 can be read by a suitable magnetic stripe reader. The details of a transaction at the point-of-sale are thereafter associated with the customer account linked to the gift card 10.

As an alternative to a magnetic stripe, the customer account information can be stored in a memory chip, embedded integrated circuits, NFC (“near field communication”) chips, RFID (“radio frequency identification”) tags, and—in certain embodiments—within the machine-readable indicia 14 itself (i.e., together with the internet link encoded therein). As to the latter, a magnetic stripe would be unnecessary, and if desired, could be eliminated.

Machine-readable element 14 can employ any well-known technology for storing data, including the aforementioned magnetic stripe technology. Machine-readable indicia capable of being read by an optical scanner is however preferred. Configured as such, optical scanning can be performed “on-the-spot” using, for example, a smartphone equipped with a digital camera and appropriate image analyzing software. With such smartphones currently in wide pervasive use, scanning and access can be expected to be performed virtually anywhere, anytime, and by most (if not all) potential customers.

Appropriately integrated with the retailer's computer network and equipped with a card-reading device (or other user input interface), customer scanning and/or account access can also be performed within an actual retailer-operated store, for example, at a networked customer-information kiosk or shopping-cart mounted computing tablets. Suitable information kiosks are currently available from a number of sources, for example, the “SelfServ”-branded family of information kiosks available from NCR Corporation (Duluth, Ga.); and the “AnyPlace”-branded family of information kiosks available from IBM Corporation (Armonk, N.Y.). An example of a tablet-equipped shopping cart is the “Smart Cart”-branded shopping cart available from SK Telecom Co., Ltd. (Seoul, South Korea).

Useful and/or desirable formats for machine-readable indicia would include any of the matrix, geometric, and bar code formats currently available and well known to those skilled in the art. Examples of such formats can be found in U.S. Pat. No. 5,504,322, issued to T. Pavlidis et al. on Apr. 2, 1996; U.S. Pat. No. 5,959,285, issued to F. Schuessler on Sep. 28, 1999; U.S. Pat. No. 8,011,596, issued to A. Longacre on Sep. 6, 2011; and U.S. Pat. No. 6,830,197, issued to K. T. Rubin on Dec. 14, 2004. Due in part to its storage capacity—and in part to its widespread adoption by retailers, customers, and smartphone application developers—the preferred format is the so-called QR code format.

As shown in FIG. 1, the QR (“Quick Response”) code is a high density matrix bar code that utilizes three square targets at three of its corner (i.e., upper left, upper right, and bottom left corners) and a smaller square target near its fourth corner to normalize the code image for size, orientation, and angle of viewing. The international standard and technical specifications for the creation and use of QR codes are defined in ISO/IEC 18004, available from the International Organization for Standardization (ISO) in Geneva, Switzerland (<http://www.iso.org>).

The amount of data stored in a QR code will largely depends on the overall dimensions of the array. “Version 1” of a standards-compliant QR code (i.e., the least capacious version) is a 21×21 array having a capacity of 72 data bits at high (type “H”) error correction. “Version 40” (i.e., the most capacious) is a 177×177 array having a capacity of approximately 23K at low (type “L”) error correction. The amount of data storage capacity needed to practice the present invention will vary, as will the types of data encoded within that capacity. Regardless, in all instances, at least a portion (if not the majority) of this capacity will be used to encode a link to the internet-accessible customer account. The “link” can be a “hyperlink”, a “pointer” to a customer account file or data location, a “routing path”, or other addressing scheme capable of enabling access to a state of interactive digital communication with the customer account. In the preferred embodiment, a standards-compliant QR code is used to encode a website URL corresponding to or leading into the internet-accessible customer account.

To provide security, an authentication page requesting card identification, account name, password, and/or PIN information can be used as a gateway into the customer account. As known by those skilled in the art, certain authentication information can be extracted automatically, for example, by analyzing packet header information for unique device identification numbers (e.g., MAC addresses and SIM numbers), or facilitated, by depositing so-called “cookies” onto a customer computing device.

As shown, in FIG. 1, the machine readable code can be scanned using a smartphone 20 utilizing a QR code reader application 22 installed thereon.

Such applications typically provide a target 24 for framing an image of the QR code 14 electronically viewed through the smartphone 20's digital camera (not illustrated). Once targeted, the QR code is read and processed by the QR code reader application.

When properly formatted to encode a URL link, the QR code reader will open the encoded website, providing customer access thereto.

As shown in FIG. 1, the encoded URL on gift card 20 leads to the internet-accessible customer account 30 entitled “Gift Card Account”. In accordance with embodiments of the present invention, internet accessible customer account 20 provides access to monetary value data 32 and transaction data 34. Hyperlinks 40 can be used to provides the customer with access to further or more particular details, data, or documentation associated with or relating to particular transactions (e.g., the invention's electronic receipts).

Currently-available QR code readers for smartphones include, but are not limited to, the “Optiscan” reader for iPhone (developed by Airsource Limited, Cambridge, UK, available on iTunes; the “QRafter” reader for iPhone (developed by Kerem Erkan, available on iTunes); the “Barcode Scanner” for Android (developed by the Zxing Team Open Source Project, available at Google Play <https://play. google.com/store>); the “QR Pal” reader for Android (QR Pay Ltd., Warrington, UK, available at <qrpal.com/download/ android>); and the “PhraseMeme Scanner” for Windows Mobile (developed by Greg Bray, available at <www.windowsphone.com>).

To enable broader flexibility in the design of the system, a QR reader can be custom-developed as an integrated utility within a primary retailer branded multifunctional smartphone application, together with other customer utilities, such as shopping list generators, price checkers and comparators, store locators, digital coupon wallets, etc. Since the QR reader would execute in such embodiment within the retailer's own application, software, and/or network (cf., an essentially “closed” computing environment), strict adherence to, for example, the ISO standards required for cross platform compatibility can be relaxed substantially.

To illustrate, a comparatively long URL format for encoding a website address can be replaced by a shorter numeric code relating to a URL address on a lookup table stored within a retailer-operated data storage facility. Smaller QR arrays can be used on cards (which can provide cosmetic advantages), with enhanced QR code analysis and security added or distributed further into the core of a retailer's computing network (which can provide operational advantages).

As mentioned above, the customer account linked gift card 10—or more specifically, the customer account which the card represents—is used by a customer to purchase merchandise from a retailer-operated point-of-sale.

The point-of-sale can either be located at an actual physical store, such as a department store checkout counter, or virtually-located, such as an online e-commerce website. When used at a physically-located store, the card is presented at checkout to either a store associate or self-service checkout machine, whereupon the customer account identification number is read and/or inputted and account access enabled. Similarly, at an e-commerce site, account access is enabled by inputting the card's identification number in response to, for example, a “login” script.

At a point-of-sale, merchandise is identified (by name, quantity, and price) and recorded by the retailer. A final calculated price (including any applicable taxes, discounts, shipping and handling charges, and other adjustments) is then presented to the customer, whereupon the customer arranges for payment. The customer can elect to apply all or some of the monetary value of the gift card towards payment of the final price, or arrange for other form of payment (i.e., cash, credit, or debit).

In any event, once payment is arranged, the transaction is recorded in the customer account, effecting either the transaction and/or monetary value data stored therein. In circumstances where the gift card is used for payment, both the transaction and monetary value data will likely be affected.

Once payment is received, the retailer prepares and presents to the customer a sales receipt.

In accordance with the present invention, at the direction of the customer, rather than receive a physical printed receipt at a physical point-of-sale checkout, the customer can receive an electronic receipt, the receipt being recorded within and retrievable or downloadable from the internet-accessible customer gift card account.

As used herein, the “electronic receipt” is defined as “an electronic documentation of a payment made to finalize a sale”. In addition to documenting actual receipt of payment, the electronic sales receipt preferably also identifies all goods and services involved, as well as prices, quantities, credits, discounts, taxes, account, and form of payment.

The electronic receipt can be stored in the retailer's computer network as a single document file, such as a PDF (portable document format) file or TIFF (tagged image file format), or in multiple data files collected and compiled when prompted by a customer accessing the internet-accessible computer account.

The electronic receipt can also include information or declarations defining “general”, “product specific”, and/or “additionally purchased” warranties and guarantees, as well as refund, replacement, and return policies. Similarly, the electronic receipt can include coupons available for future purchases (cf., possibly determined from analysis of purchased merchandise), cash-back awards, or information or reports on pertinent membership or loyalty program awards, points, or milestones.

As an alternative to inclusion within an electronic receipt, the warranties, guarantees, coupons, and awards can be added as attached data files or—in other embodiments—as “stand alone” files separate from the electronic receipt.

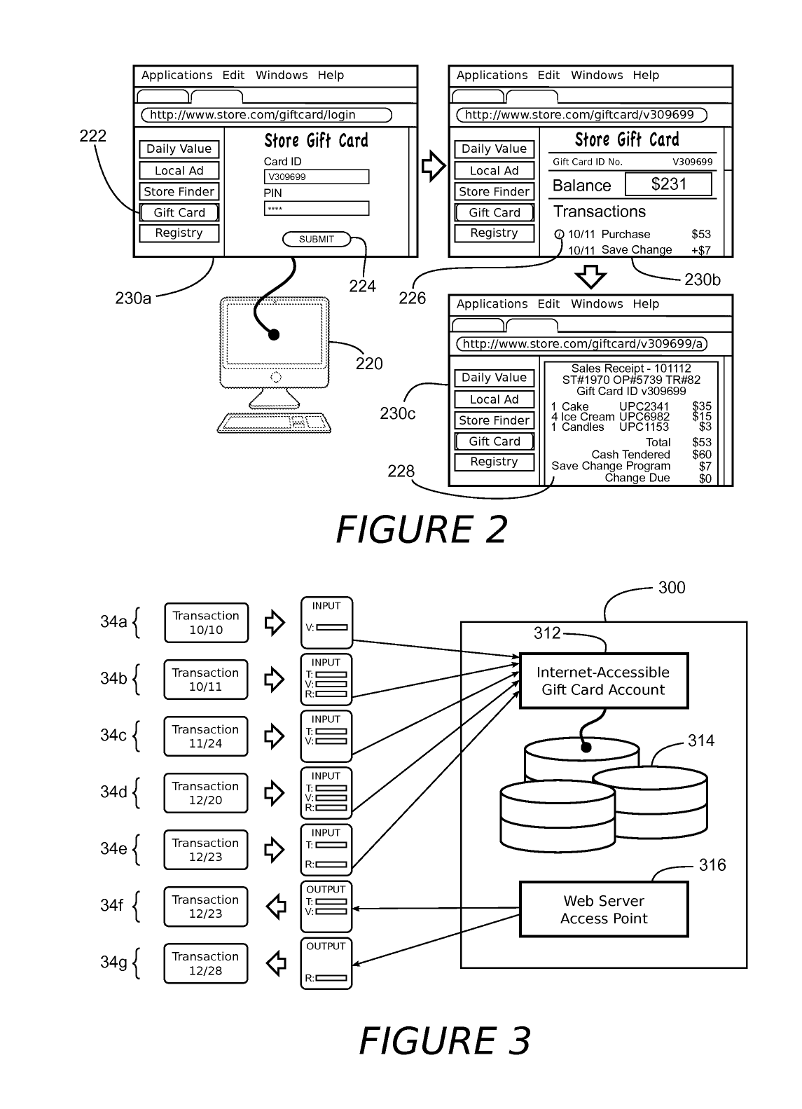

FIG. 2 illustrates an example of a customer accessing an electronic receipt 228 utilizing a personal computer 220 pursuant to one method of using the retail card gift system of the present invention.

In particular, on an internet browser installed and running on the personal computer 220, a customer initiates account access by first opening a login page 230 using navigation button 222.

The login page 230a—as shown—provides input fields for gift card authentication information (i.e., “Card ID” and “PIN”). A submit button 224—when clicked or otherwise activated—leads to capture of the customer's input, comparison to stored authentication data, and—provided authentication succeeds—launching by the browser of a gift card dashboard 230b.

The gift card dashboard 230b identifies the customer account (i.e., Gift Card ID No. V309699) and acquires from and publishes to the customer a predetermined selection of information stored in association with the customer account. Specifically, dashboard 230b provides both transaction data (cf., “Transactions”) and monetary value data (cf., “Balance”). Where a transaction had resulted in the generation of an electronic sales receipt, those receipts are either displayed at the root level of the dashboard or—as shown in FIG. 2—accessible through a hyperlink 226.

When hyperlink 226 is clicked or otherwise activated, electronic receipt 228 is displayed. Consistent with the definition provided hereinabove, electronic receipt 228 documents among other information a “payment made to finalize a sale” (i.e., “Cash Tendered $60”). In the preferred embodiment, electronic receipt 228 is displayed or otherwise provided in a format downloadable and/or printable by the customer.

As mentioned above, the gift card system of the invention can include an overpayment deposit feature. To illustrate, when checking out at a physical point-of-sale, a customer can elect to overpay the purchase (cf., paying for a $17 purchase with $20 cash). Rather, than receive the overpayment back in cash, the customer can have monetary balance transferred to the monetary value of the gift card. In particular, the card is “swiped” (i.e., read or otherwise manually inputted) and monetary balance electronically transferred to (i.e., added to) the monetary value stored in the internet-accessible gift card account.

Inclusion of such “change savings” feature provides advantages to both the customer and the retailer. For the customer, convenience is enhanced by having wider options for adding money to the gift card at a point-of-sale. For the retailer, the ability to easily add money to the gift card extends gift card usage and customer loyalty.

To illustrate further the use of the gift card, a hypothetical sequence of gift card transactions 34a to 34g, and the effect thereof on a retailer-operated computer network 330, is provided in FIG. 3.

The retailer network 330—as shown—comprises a data storage facility 314, an internet-accessible gift card account 312 hosted on the data storage facility, and a web-server access point 316 that provides an interface between a customer's internet-enabled device (e.g., a smartphone or personal computer) and the data stored in association with the gift card account.

Customer transaction 34a, dated October 10, represents the purchase and activation of a customer gift card. Activation of the gift card results in the opening or creation of gift card account 312 within the retailer's computer network 300. As a result of the transaction, the starting value of the gift card is recorded as monetary value data in the card account 312 (e.g., Data Input “V”).

Customer transaction 34b, dated October 11, represents the purchase of merchandise at a retailer-operated grocery store, wherein the customer pay cash for the merchandise, requests change to be swept back into the gift card account, and requests an electronic receipt to be delivered to his gift card account. As a result of the transaction, in card account 312, the purchase of merchandise, deposit of change, and electronic receipt are recorded as transaction data (e.g., Data Inputs “T” and “R”). The value of the deposit is recorded as monetary value data (e.g., Data Input “V”).

Customer transaction 34c, dated November 24, represent the online transfer of money from a customer bank account to the gift card account. As a result of the transaction, in card account 312, the deposit is recorded as transaction data (e.g., Data

Input “T”). The value of the deposit is recorded as monetary value data (e.g., Data Input “V”). As no sale is involved, no electronic receipt is generated.

Customer transaction 34d, dated December 20, represents the purchase of merchandise from a retailer-operated department store, wherein the customer uses the gift card for payment and requests an electronic receipt. As a result of the transaction, in card account 312, the purchase of merchandise, the use of the card for payment, and the electronic receipt are recorded as transaction data (e.g., Data Inputs “T” and “R”). The value used for payment is recorded as monetary value data (e.g., Data Input “V”).

Customer transaction 34e, dated December 23, represents the purchase of merchandise from a retailer-operated e-commerce site, wherein the customer pays using a credit card and requests an electronic receipt. As a result of the transaction, in card account 312, the purchase of merchandise, the use of a credit card for payment, and the electronic receipt are recorded as transaction data (e.g., Data Inputs “T” and “R”). Since a credit card is used for payment, the monetary value of the gift card is unchanged.

Customer transaction 34f, dated December 23, represents customer access of the internet-accessible customer account 312 using a smart phone to check the card's balance and recent transactions. In response to the customer's access, appropriate transaction data and monetary value data is extracted from the gift card account 312 by web server 316 and published back to the customer's smartphone. See e.g., “Gift Card Account 30” in FIG. 1.

Finally, customer transaction 34g, dated December 28, represents customer access of the internet-accessible customer account 312 using a personal computer to download the electronic receipt recorded in customer transaction 34b, above. In response, appropriate transaction data is extracted from the gift card account 312 by web server 316 and published back to the customer's personal computer. See e.g., “Electronic Receipt 228” in FIG. 2.

Although several embodiments of the invention are disclosed hereinabove, those skilled in the art having the benefits of this disclosure can effect modifications thereto. These modifications are to be construed as being encompassed with the scope of the present invention as set forth in the appended claims.

1. A retail gift card system with integrated account and receipt tracking, the retail gift card system comprising an internet-accessible customer account and a customer account linked gift card;
wherein the internet-accessible customer account is hosted on a computer network operated by said retailer, the customer account being associated with transaction data and monetary value data stored on the computer network, the associated transaction data and monetary value data being available to said customer when said customer accesses the customer account through the internet; and
wherein the customer account linked gift card has a machine-readable element encoding a link to said internet-accessible customer account, the customer account linked gift card capable of being used by said customer to purchase merchandise from a point-of-sale operated by said retailer applying the monetary value data towards payment of said merchandise and whereby an electronic receipt is generated, both the purchase and electronic receipt being recorded in the customer account effecting both the transaction data and monetary value data.

2. The retail gift card system of claim 1, wherein the machine-readable element is indicia capable of being read by an optical scanner.

3. The retail gift card system of claim 2, wherein the machine-readable indicia is a QR code.

4. The retail gift card system of claim 3, wherein the link is a website URL leading into said internet-accessible customer account.

5. A retail gift card system comprising an internet-accessible customer account and a customer account linked gift card;
wherein the internet-accessible customer account is hosted on a computer network operated by said retailer, the customer account being associated with transaction data and monetary value data stored on the computer network, the associated transaction data and monetary value data being available to said customer when said customer accesses the customer account through the internet;
wherein the customer account linked gift card has machine-readable indicia encoding a link to said internet-accessible customer account, the machine-readable indicia capable of being read by an optical scanner; and
wherein the customer account linked gift card is:
(a) capable of use by said customer to purchase merchandise from said retailer applying the monetary value data towards payment of said merchandise, the purchase being recorded in the customer account effecting both the transaction data and the monetary value data; and
(b) capable of use by said customer to effect recording of a monetary balance remaining from an overpayment of a purchase of merchandise from said retailer at a point-of-sale at a retailer-operated store, the recorded monetary balance being transferred to the monetary value data stored in the customer account.

6. The retail gift card system of claim 5, wherein the machine-readable indicia is a QR code.

7. The retail gift card system of claim 6, wherein the link is a website URL leading into said internet-accessible customer account.
